(19) United States
(12) Patent Application Publication
(10) Pub. No.: US 2025/0353502 A1
(43) Pub. Date: Nov. 20, 2025

(54) VEHICLE CONTROL DEVICE, VEHICLE CONTROL METHOD, AND COMPUTER PROGRAM FOR VEHICLE CONTROL

(71) Applicant: TOYOTA JIDOSHA KABUSHIKI KAISHA, Toyota-shi Aichi-ken (JP)

(72) Inventor: Kenta Kumazaki, Bunkyo-ku Tokyo-to (JP)

(73) Assignee: TOYOTA JIDOSHA KABUSHIKI KAISHA, Toyota-shi Aichi-ken (JP)

(21) Appl. No.: 19/204,711

(22) Filed: May 12, 2025

(30) Foreign Application Priority Data
May 15, 2024 (JP) 2024-079323

(51) Int. Cl. B60W 30/182; B60W 30/14; B60W 30/16; B60W 30/18

(52) U.S. Cl. CPC B60W 30/182; B60W 30/146; B60W 30/16; B60W 30/18127; B60W 2510/244; B60W 2554/802

(57) ABSTRACT

A vehicle control device includes a processor configured to control a motor mounted on a vehicle when the vehicle decelerates so that a regenerative electric energy obtained by the motor during deceleration of the vehicle when an acceleration/deceleration control mode is applied to the vehicle is smaller than the regenerative electric energy when the acceleration/deceleration control mode is not applied to the vehicle by a predetermined adjustment amount, the acceleration/deceleration control mode being a mode in which a acceleration/deceleration of the vehicle is controlled according to a distance between the vehicle and a preceding vehicle.

### CROSS-REFERENCE TO RELATED APPLICATIONS

This application claims priority to Japanese Patent Application No. 2024-079323 filed May 15, 2024, the entire contents of which are herein incorporated by reference.

### FIELD

The present disclosure relates to a vehicle control device, a vehicle control method, and a computer program for controlling a vehicle.

### BACKGROUND

A technique has been proposed for switching a control mode of an electric motor so that the regenerative electric energy by the electric motor increases when it is determined that the state of charge of a battery serving as a power source of the electric motor for driving a vehicle has decreased in order to avoid the inability to travel due to a decrease in the state of charge while suppressing a change in the behavior applied to the vehicle (see Japanese Unexamined Patent Publication JP2019-193357A).

### SUMMARY

When the regenerative torque is increased in order to increase the regenerative electric energy, noise generated by the motor when the regenerative electric power is obtained during deceleration of the vehicle (hereinafter, referred to as regenerative noise) also increases. In particular, in the case where the deceleration control is automatically executed as in the case where the driving assistance control is executed on the vehicle, the driver is likely to feel uncomfortable with respect to the regenerative noise because the driver is less careful about the driving operation. Further, in order to increase the obtained regenerative electric energy, if the regenerative control is continued so that the regenerative torque is generated until immediately before the vehicle is stopped, the variation of the acceleration immediately before the stop is relatively increased, so that the shock at the time of the stop is increased.

Therefore, it is an object of the present disclosure to provide a vehicle control device capable of reducing the discomfort of a driver caused by execution of regeneration control.

A vehicle control device according to an embodiment includes a processor configured to control a motor mounted on a vehicle when the vehicle decelerates so that a regenerative electric energy obtained by the motor during deceleration of the vehicle when an acceleration/deceleration control mode is applied to the vehicle is smaller than the regenerative electric energy when the acceleration/deceleration control mode is not applied to the vehicle by a predetermined adjustment amount, the acceleration/deceleration control mode being a mode in which acceleration/deceleration of the vehicle is controlled according to a distance between the vehicle and a preceding vehicle.

In one embodiment, the processor decreases the adjustment amount as a remaining amount of a battery mounted on the vehicle decreases.

In one embodiment, the processor decreases the adjustment amount as a noise around the vehicle or in the vehicle interior increases.

A vehicle control method according to another embodiment includes controlling a motor mounted on a vehicle when the vehicle decelerates so that a regenerative electric energy obtained by the motor during deceleration of the vehicle when an acceleration/deceleration control mode is applied to the vehicle is smaller than the regenerative electric energy when the acceleration/deceleration control mode is not applied to the vehicle by a predetermined adjustment amount, the acceleration/deceleration control mode being a mode in which acceleration/deceleration of the vehicle is controlled according to a distance between the vehicle and a preceding vehicle.

A non-transitory recording medium that stores a computer program for vehicle control according to still another embodiment includes instructions causing a processor mounted on a vehicle to execute a process including: controlling a motor mounted on the vehicle when the vehicle decelerates so that a regenerative electric energy obtained by the motor during deceleration of the vehicle when an acceleration/deceleration control mode is applied to the vehicle is smaller than the regenerative electric energy when the acceleration/deceleration control mode is not applied to the vehicle by a predetermined adjustment amount, the acceleration/deceleration control mode being a mode in which acceleration/deceleration of the vehicle is controlled according to a distance between the vehicle and a preceding vehicle.

The vehicle control device according to the present disclosure can reduce the discomfort of the driver caused by the execution of the regeneration control.

### BRIEF DESCRIPTION OF DRAWINGS

FIG. 1 schematically illustrates the configuration of a vehicle equipped with a vehicle control device.

FIG. 2 is a functional block diagram of a processor of an electronic control unit related to vehicle control process.

FIG. 3 is a schematic explanatory diagram of adjustment of regenerative torque according to the present embodiment.

FIG. 4 is an operation flowchart of a vehicle control process according to the present embodiment.

### DESCRIPTION OF EMBODIMENTS

Hereinafter, a vehicle control device, a vehicle control method executed on the vehicle control device, and a computer program for vehicle control will be described with reference to the drawings. The vehicle control device controls a vehicle to increase a regenerative electric energy at the time of deceleration by a motor mounted in the vehicle, in a case where a remaining amount of a battery of the vehicle is equal to or less than a predetermined threshold, more than the regenerative electric energy in a case where the remaining amount of the battery is larger than the threshold. Further, the vehicle control device reduces an increase in the regenerative electric energy when a acceleration/deceleration control mode for automatically controlling the acceleration/deceleration of the vehicle in accordance with a distance between a preceding vehicle and the vehicle is applied to the vehicle, by a predetermined adjustment amount smaller than the increase in the regenerative electric energy when the acceleration/deceleration control mode is not applied, thereby reducing the discomfort of a driver caused by the execution of the regenerative control.

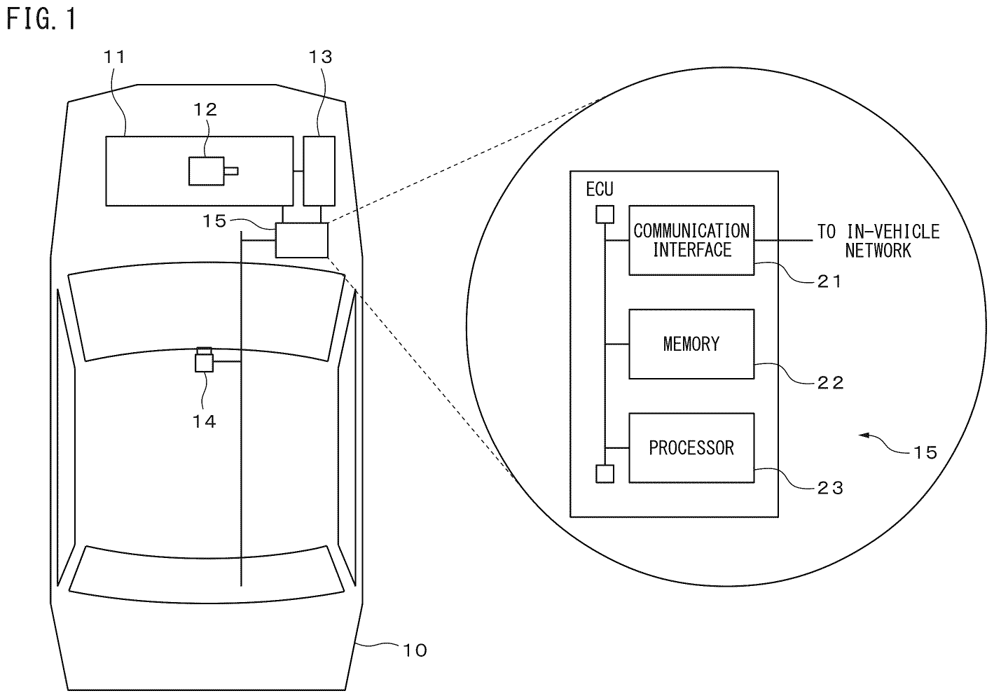

FIG. 1 schematically illustrates the configuration of a vehicle equipped with a vehicle control device. In the present embodiment, the vehicle 10 is a battery electric vehicle, hybrid, or plug-in hybrid vehicle, and a powertrain 11 of the vehicle 10 includes a motor 12 as a power source for driving or a generator for regenerative energy recovery. Further, the vehicle 10 includes a battery 13 for supplying electric power to each unit of the vehicle 10, and the vehicle 10 is capable of recovering regenerative energy and charging the battery 13 by operating the motor 12 as a generator at the time of deceleration. Further, the vehicle 10 includes an exterior sensor 14 and an electronic control unit (ECU) 15.

The exterior sensor 14 is a sensor that generates an exterior sensor signal representing a situation around the vehicle 10, and is, for example, a camera that is provided so as to be capable of capturing an image of the surroundings of the vehicle 10, or a ranging sensor such as a LiDAR or a radar. The vehicle 10 may be provided with a plurality of exterior sensors 14 having different detectable ranges or types. Each time the exterior sensor signal is generated, the exterior sensor 14 outputs the generated exterior sensor signal to the ECU 15.

The ECU 15, which is an example of a vehicle control device, is capable of executing an acceleration/deceleration control mode in which the acceleration/deceleration of the vehicle 10 is automatically controlled in accordance with a distance between a preceding vehicle and the vehicle 10. Note that the acceleration/deceleration control may be executed as one function of the driving support control or as one function of the autonomous driving control. That is, the driving support mode and the autonomous driving mode are examples of the acceleration/deceleration control mode. The ECU 15 also executes regeneration control by the motor 12 when the vehicle 10 decelerates.

The ECU 15 includes a communication interface 21, a memory 22, and a processor 23. The communication interface 21, the memory 22, and the processor 23 may each be configured as separate circuits or may be integrally configured as a single integrated circuit.

The communication interface 21 has interface circuitry for connecting the ECU 15 to other devices. The communication interface 21 passes a signal from the exterior sensor 14 to the processor 23. Further, the communication interface 21 outputs a control signal of the powertrain 11 received from the processor 23 to the powertrain 11.

The memory 22 is an example of a storage unit, and includes a volatile semiconductor memory and a non-volatile semiconductor memory. The memory 22 stores various types of data used in the vehicle control process executed by the processor 23 or generated during the execution of the vehicle control process.

The processor 23 includes one or more central processing units (CPUs) and its peripheral circuitry. The processor 23 may further include other arithmetic circuits such as a logical operation unit, a numerical operation unit, or a graphics processing unit. Then, the processor 23 executes the vehicle control process on the vehicle 10.

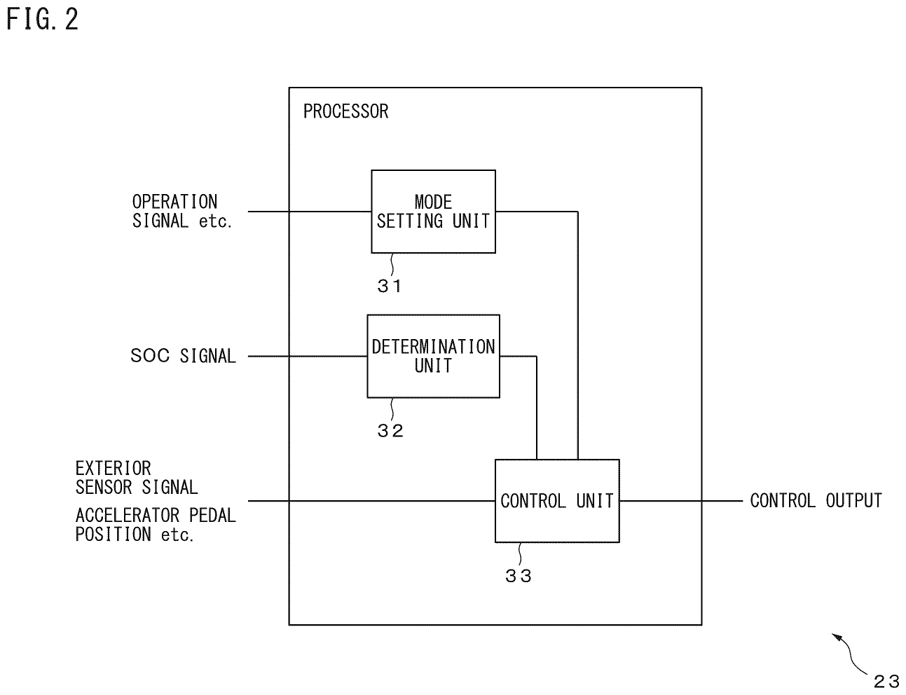

FIG. 2 is a functional block diagram of the processor 23 related to the vehicle control process. The processor 23 includes a mode setting unit 31, a determination unit 32, and a control unit 33. Each of these units included in the processor 23 is, for example, a functional module implemented by a computer program executed by the processor 23. Alternatively, each of these units may be a dedicated operating circuit provided in the processor 23.

The mode setting unit 31 sets the driving mode to be applied to the vehicle 10 to a mode designated by an operation signal from an operation device (not shown) provided in the vehicle interior of the vehicle 10. That is, when the operation signal indicates that the driving mode (the driving support mode or the autonomous driving mode) including the acceleration/deceleration control is set, the mode setting unit 31 applies the driving mode to the vehicle 10. Further, when the operation signal indicates to set the manual driving mode indicating that manual driving is performed by the driver, the mode setting unit 31 applies the manual driving mode to the vehicle 10. Every time the driving mode to be applied to the vehicle 10 is changed through the operation of the operating device, the mode setting unit 31 notifies the control unit 33 of the changed driving mode.

The determination unit 32 acquires a signal representing the remaining amount from the battery 13 every predetermined period (for example, 1 second to several seconds), for example, the signal representing the state of charge (State Of Charge (SOC), and compares the remaining amount of the battery represented by the signal with a predetermined threshold (for example, 30% to 60% of the state of full charge). Then, the determination unit 32 determines whether or not the remaining amount of the battery is equal to or less than the predetermined threshold at every predetermined period, and notifies the control unit 33 of the determination result.

The control unit 33 controls the traveling of the vehicle 10 in accordance with the driving mode which is applied to the vehicle 10. Further, the control unit 33 executes control of the powertrain 11 when the vehicle 10 decelerates, in particular, executes regeneration control for the motor 12, according to the determination result by the determination unit 32 and the driving mode to be applied.

When the manual driving mode is applied (that is, when the acceleration/deceleration control mode is not applied), the control unit 33 refers to a map representing a relationship between an accelerator position of the accelerator device (not shown), a rotational speed of the engine or the motor 12 included in the powertrain 11, and a target torque. In accordance with the map, the control unit 33 sets the target torque in accordance with the accelerator position corresponding to the operating amount of the accelerator pedal by the driver and generates the control signal of the powertrain 11 in accordance with the set target torque. Then, the control unit 33 outputs the generated control signal to the powertrain 11. At this time, the control unit 33 may control the powertrain 11 such that the torque actually outputted approaches the target torque in accordance with the feedback control such as PID control. Further, when the driver depresses the brake pedal, the control unit 33 sets a target torque for decelerating the vehicle 10 in accordance with the amount of depression of the brake pedal by the driver and controls the powertrain 11 including the brake device (not shown) and the motor 12 in accordance with the set target torque.

In particular, when the vehicle 10 decelerates, the target torque is determined to be a sum of a braking torque for decelerating the vehicle 10 by the brake device and a regenerative torque by the motor 12. Therefore, the control unit 33 determines the braking torque and the regenerative torque by referring to a map indicating a relationship between the vehicle speed of the vehicle 10 measured by a speed sensor (not shown) mounted on the vehicle 10, the amount of depression of the brake pedal, the amount of rotation of the motor 12, the amount of rotation of the engine (when the engine is included in the powertrain 11), the braking torque, and the regenerative torque. Such map is stored in advance in the memory 22.

When the regenerative torque is not 0, the regenerative electric power corresponding to the regenerative torque is generated by the motor 12. Therefore, the regenerative electric energy is obtained as the sum of the regenerative electric power in a period in which the regenerative torque is generated (that is, a period in which the regenerative torque is not 0). Further, when the determination result received from the determination unit 32 indicates that the remaining battery amount is equal to or less than the predetermined threshold, the control unit 33 increases the regenerative torque so that the regenerative electric energy increases as compared with the case where the remaining battery amount is larger than the threshold. At this time, the control unit 33 may increase the regenerative torque itself at each speed, or may expand the speed range in which the regenerative torque is generated to a lower speed range. Alternatively, the control unit 33 may increase the regenerative electric energy obtained by both increasing the regenerative torque itself and expanding the speed range in which the regenerative torque is generated. Then, the control unit 33 corrects the target torque so that the target torque increases by an increase in the regenerative torque. For this reason, when the remaining battery amount is equal to or less than the threshold, the control unit 33 may determine the increase amount of the regenerative torque at each speed by referring to a table in which the increase amount of the regenerative torque at each speed is set. Such a table is stored in advance in the memory 22.

While the driving assistance mode or the autonomous driving mode is applied to the vehicle 10, the control unit 33 controls the powertrain 11 and the brake device so that the vehicle 10 travels at the target vehicle speed. Further, the control unit 33 controls the powertrain 11 and the brake device so that the distance between the vehicle 10 and a preceding vehicle traveling ahead of the vehicle 10 in the host lane in which the vehicle 10 is traveling is maintained at a predetermined distance or more. The target vehicle speed is set via an operation device in the vehicle 10. Alternatively, the control unit 33 may specify the road section in which the vehicle 10 is traveling on the basis of the map information representing the legal speed of each road section and the current position of the vehicle 10, specify the legal speed of the road section, and set the target vehicle speed to the specified legal speed. Such map information is stored in advance in the memory 22 or a storage device (not shown) for storing the map information. The current position of the vehicle 10 may be determined by a receiver (not shown) of a satellite positioning system mounted on the vehicle 10.

In order to detect the preceding vehicle, the control unit 33 detects another vehicle traveling around the vehicle 10. To this end, the control unit 33 detects another vehicle by inputting an exterior sensor signal, which is obtained by the exterior sensor 14 and represents a situation of a region around the vehicle 10, to a classifier learned in advance so as to detect another vehicle traveling around the vehicle 10. The classifier may be a deep neural network (DNN) based classifier having a convolutional neural network (CNN) type architecture or attention mechanisms.

When the exterior sensor 14 is a camera provided to photograph the surroundings of the vehicle 10 and the exterior sensor signal is an image, the classifier detects an object region in which another vehicle detected on the image is represented. Further, the control unit 33 detects the lane division line by inputting the image generated by the camera to a classifier for detecting the lane division line learned in advance so as to detect the lane division line. The classifier for lane division line detection may be a DNN for semantic segmentation, such as a U-net. Alternatively, the classifier for detecting other vehicles may be learned in advance to also detect lane dividing lines. Then, the control unit 33 sets, on the image, a region sandwiched between the two lane division lines closest to the vehicle 10 among the detected lane division lines as the host lane region representing the host lane. The control unit 33 may specify, among the detected other vehicles, the vehicle represented in the object region whose bottom end position is included in the host lane region and which is closest to the lower end of the image as the preceding vehicle. Alternatively, the control unit 33 may specify, as the preceding vehicle, the vehicle located in an azimuth corresponding to the traveling direction of the vehicle 10 among the detected other vehicles. Then, the control unit 33 estimates the distance from the vehicle 10 to the preceding vehicle.

The position of the bottom end of the object region representing the preceding vehicle is assumed to represent the position at which the preceding vehicle is in contact with the road surface. The position on the image corresponds one-to-one to the direction viewed from the camera that generated the image. Therefore, the control unit 33 can estimate the distance and the azimuth from the camera to the preceding vehicle by referring to the position of the bottom end of the object region in which the preceding vehicle is represented on the image and parameters of the camera such as the installation height, the shooting direction, and the angle of view.

In addition, in a case where the exterior sensor 14 is a range sensor, the control unit 33 specifies, among the other detected vehicles, the vehicle detected in an azimuth corresponding to the traveling direction of the vehicle 10 as the preceding vehicle. Then, the control unit 33 may estimate the distance measured with respect to the azimuth in which the detected preceding vehicle is represented as the distance between the vehicle 10 and the preceding vehicle.

The control unit 33 sets a target acceleration/deceleration so as to decelerate the vehicle 10 when the estimated distance to the preceding vehicle (hereinafter, sometimes simply referred to as the inter-vehicle distance) is less than the predetermined distance. At this time, the control unit 33 sets the target acceleration/deceleration so that the deceleration becomes larger as the inter-vehicle distance to the preceding vehicle is shorter or the relative speed of the vehicle 10 with respect to the preceding vehicle is faster. On the other hand, when the estimated inter-vehicle distance to the preceding vehicle is equal to or more than the predetermined distance, the control unit 33 sets the target acceleration/deceleration so that the speed of the vehicle 10 approaches the target vehicle speed. However, when the speed of the preceding vehicle is lower than the target vehicle speed, the control unit 33 sets the target acceleration/deceleration so that the inter-vehicle distance becomes the predetermined distance and the relative speed between the vehicle 10 and the preceding vehicle becomes zero. For this purpose, the control unit 33 sets the target acceleration/deceleration based on, for example, a relational expression between the inter-vehicle distance, the relative speed, and the target acceleration/deceleration. Then, the control unit 33 determines a target torque corresponding to the set target acceleration/deceleration speed, and outputs a control signal corresponding to the target torque to the powertrain 11 including the motor 12 and the brake device.

In this case as well, when the target acceleration/deceleration indicates the deceleration of the vehicle 10, the control unit 33 sets the target torque so as to be the sum of the braking torque and the regenerative torque. The control unit 33 may determine the braking torque and the regenerative torque by referring to a map indicating a relationship between the target acceleration/deceleration, the speed of the vehicle 10 measured by the speed sensor, the rotation amount of the motor 12, the rotation amount of the engine (when the engine is included in the powertrain 11), the braking torque, and the regenerative torque. Further, when the determination result received from the determination unit 32 indicates that the remaining battery amount is equal to or less than the predetermined threshold, the control unit 33 increases the regenerative torque so that the regenerative electric energy increases as compared with a case where the remaining battery amount is larger than the threshold. Then, the control unit 33 corrects the target torque so that the target torque increases by an increase in the regenerative torque. Also in this case, the control unit 33 may increase the regenerative torque itself, or may expand the speed range in which the regenerative torque is generated to a lower speed range. Alternatively, the control unit 33 may increase the regenerative electric energy obtained by both an increase in the regenerative torque itself and an increase in the speed range in which the regenerative torque is generated.

However, the control unit 33 sets the increment of the regenerative electric energy so that the increment of the regenerative electric energy when the driving support mode or the autonomous driving mode is applied to the vehicle 10 is smaller than the increment of the regenerative electric energy when the manual driving mode is applied to the vehicle 10 by a predetermined adjustment amount. At this time, the control unit 33 reduces the increase amount of the regenerative torque when the driving support mode or the automatic driving mode is applied to the vehicle 10, rather than the increase amount of the regenerative torque when the manual driving mode is applied to the vehicle 10. Alternatively, the control unit 33 may make the speed range in which the regenerative torque is generated when the driving support mode or the automatic driving mode is applied to the vehicle 10 narrower than the speed range in which the regenerative torque is generated when the manual driving mode is applied to the vehicle 10. Alternatively, the control unit 33 may reduce an increase amount of the regenerative torque when the driving support mode or the automatic driving mode is applied to the vehicle 10 and narrow a speed range in which the regenerative torque is generated as compared with a case where the manual driving mode is applied to the vehicle 10. The control unit 33 may determine the amount of increase in the regenerative torque at each speed by referring to a table in which the amount of increase in the regenerative torque at each speed is set so that the amount of regenerative electric energy is reduced by a predetermined adjustment amount. Such a table is stored in advance in the memory 22. Thus, when the driving support mode or the autonomous driving mode is applied to the vehicle 10 in which the driver is easily directed to the regenerative noise, the regenerative noise is suppressed as compared with the case where the manual driving mode is applied to the vehicle 10. Further, since the change in the acceleration of the vehicle 10 in the front and back direction when the vehicle 10 stops is reduced, the shock felt by the driver is reduced.

Even if the driving support mode or the autonomous driving mode is applied to the vehicle 10, when the driver depresses the accelerator pedal or the brake pedal by a predetermined amount or more, the control unit 33 may control the powertrain 11 and the brake device in accordance with the driving operation by the driver. In this case, the control unit 33 may also determine the regenerative torque and the target torque at the time of deceleration in the same manner as in the application of the manual operation mode.

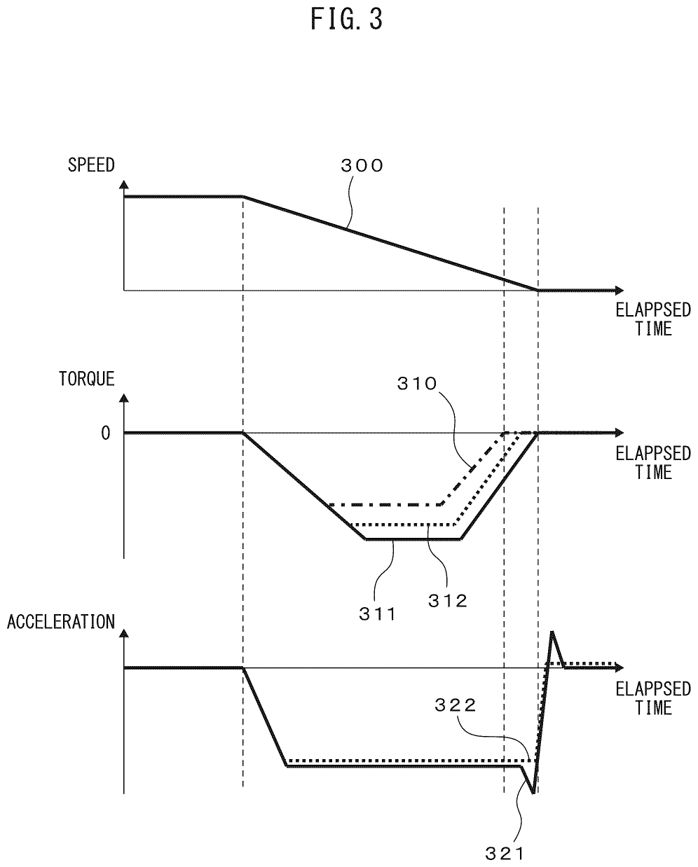

FIG. 3 is a schematic explanatory diagram of adjustment of regenerative torque according to the present embodiment. In FIG. 3, the horizontal axis represents elapsed time. In the uppermost time chart, the vertical axis represents the speed, and the graph 300 represents t a temporal change in the speed of the vehicle 10. In the second time chart from the top, the vertical axis represents torque. A negative value of the torque indicates that the torque decelerates the vehicle 10. The graph 310 represents a temporal change in the regenerative torque when the remaining amount of the battery 13 is larger than the threshold. The graph 311 represents a temporal change in the regenerative torque when the remaining amount of the battery 13 is equal to or less than the threshold and the manual operation mode is applied to the vehicle 10. Further, the graph 312 represents a temporal change in the regenerative torque when the remaining amount of the battery 13 is equal to or less than the threshold and the driving mode including the acceleration/deceleration control (i.e., the driving support mode or the autonomous driving mode) is applied to the vehicle 10. In the bottom time chart, the vertical axis represents acceleration. The graph 321 represents a temporal change in the acceleration of the vehicle 10 in the front and back direction when the remaining amount of the battery 13 is equal to or less than the threshold and the manual driving mode is applied. Further, the graph 322 represents a temporal change in the acceleration of the vehicle 10 in the front and back direction when the remaining amount of the battery 13 is equal to or less than the threshold and the driving mode including the acceleration/deceleration control is applied to the vehicle 10.

As shown in the graphs 310 to 312, when the remaining amount of the battery 13 becomes equal to or less than the threshold value, there is a period in which the absolute value of the regenerative torque increases as compared with the case where the remaining amount of the battery 13 is larger than the threshold, and thus the obtained regenerative electric energy also increases. However, the increase amount of the absolute value of the regenerative torque when the driving mode including the acceleration/deceleration control is applied to the vehicle 10 is smaller than the increase amount of the absolute value of the regenerative torque when the manual operation mode is applied to the vehicle 10. Further, the speed range in which the regenerative torque is generated when the driving mode including the acceleration/deceleration control is applied to the vehicle 10 is narrower than the speed range in which the regenerative torque is generated when the manual operation mode is applied to the vehicle 10. From this, it can be seen that, as shown in the graph 321 and the graph 322, when the driving mode including the acceleration/deceleration control is applied to the vehicle 10, the absolute value of the acceleration in the front and back direction is smaller than when the manual driving mode is applied to the vehicle 10, and in particular, the vibration of the acceleration before and after the stop is eliminated. From this, it can be seen that when the driving mode including the acceleration/deceleration control is applied to the vehicle 10, although the increase in the obtained regenerative electric energy is smaller than when the manual operation mode is applied to the vehicle 10, the regenerative noise and the shock at the time of stopping are suppressed.

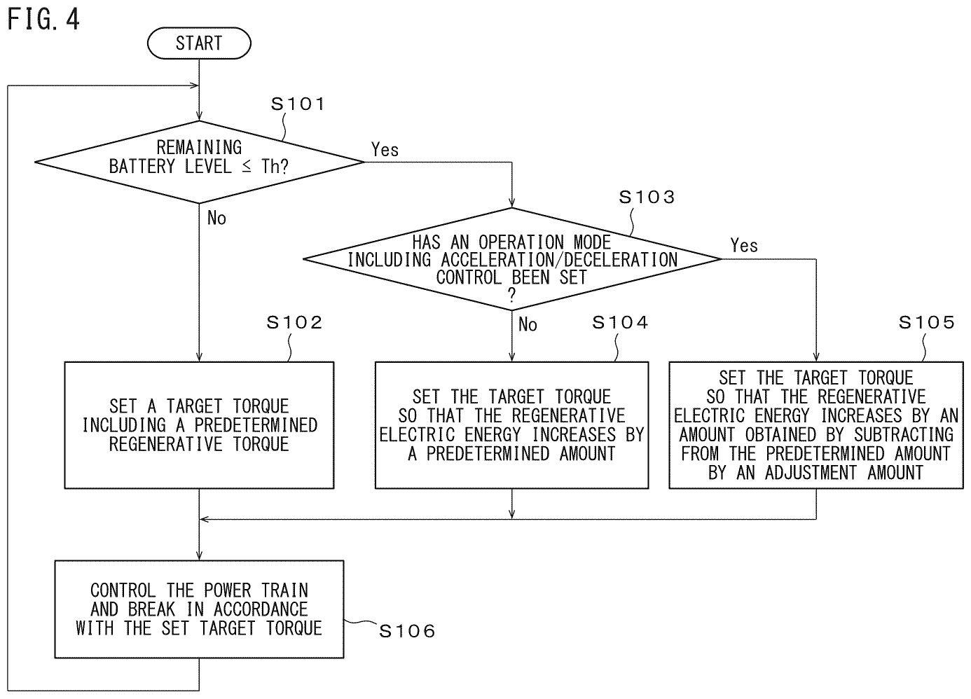

FIG. 4 is an operation flowchart of the vehicle control process according to the present embodiment.

The determination unit 32 determines whether or not the remaining amount of the battery 13 is equal to or less than a predetermined threshold Th (step S101). When the remaining amount of the battery 13 is larger than the predetermined threshold Th (No in step S101), the control unit 33 sets a target torque including a predetermined regenerative torque on the basis of the accelerator position, the brake depression amount, the distance to the preceding vehicle, and the like (step S102).

When the remaining amount of the battery 13 is equal to or less than the predetermined threshold Th (Yes in step S101), the control unit 33 determines whether or not a driving mode including acceleration/deceleration control is applied to the vehicle 10 (step S103). When the driving mode including the acceleration/deceleration control is not applied (No in step S103), the control unit 33 sets the target torque by increasing the regenerative torque so that the regenerative electric energy obtained during the deceleration is increased as compared with the case where the remaining amount of the battery 13 is larger than the predetermined threshold Th (step S104).

On the other hand, when the driving mode including the acceleration/deceleration control is set (Yes in step S103), the control unit 33 sets the target torque by increasing the regenerative torque such that the regenerative electric energy obtained during the deceleration increases by the amount obtained by subtracting the adjustment amount from the predetermined increase as compared with the case where the remaining amount of the battery 13 is larger than the predetermined threshold Th (step S105).

After the step S102, S104 or S105, the control unit 33 controls the powertrain 11 and the braking device according to the set target torque (step S106).

As described above, the vehicle control device controls the vehicle to increase the regenerative electric energy obtained during deceleration in a case where the remaining amount of the battery of the vehicle is equal to or less than a predetermined threshold than the regenerative electric energy obtained during deceleration in a case where the remaining amount of the battery is larger than the threshold. Further, the vehicle control device makes the increment of the regenerative electric energy when the acceleration/deceleration control mode is applied to the vehicle smaller by a predetermined adjustment amount than the increment of the regenerative electric energy when the acceleration/deceleration control mode is not applied. Thus, when the acceleration/deceleration control mode is applied in which the driver's attention is easily directed other than driving, the regenerative noise during the regenerative control and the shock at the time of stopping the vehicle are reduced. Therefore, the vehicle control device can reduce the discomfort of the driver caused by the execution of the regeneration control.

According to the modification, the control unit 33 may decrease the adjustment amount of the increment of the regenerative electric energy, which is a difference between when the acceleration/deceleration control mode is set and when the acceleration/deceleration control mode is not set, as the remaining amount of the battery 13 decreases. In this case, by referring to a table representing the relationship between the remaining amount of the battery and the regenerative torque for each speed when the acceleration/deceleration control mode is applied, the control unit 33 may determine the regenerative torque for each speed so that the regenerative electric energy obtained by the adjustment amount is reduced. Such a table may be stored in advance in the memory 22. Thus, even if the acceleration/deceleration control mode is set, the regenerative electric energy obtained during deceleration increases as the remaining amount of the battery 13 decreases. Therefore, the vehicle control device can balance the reduction of the discomfort of the driver and the obtained regenerative electric energy.

According to another modification, the control unit 33 may decrease the adjustment amount of the increment of the regenerative electric energy as the noise in the vicinity of the vehicle 10 or in the vehicle interior of the vehicle 10 increases. In this case as well, by referring to a table representing the relationship between the degree of noise and the regenerative torque for each speed when the acceleration/deceleration control mode is applied to the vehicle 10, the control unit 33 may determine the regenerative torque for each speed so that the obtained regenerative electric energy is reduced by the adjustment amount. Such a table may be stored in advance in the memory 22. The larger the noise around the vehicle 10 or in the vehicle interior of the vehicle 10, the less the driver notices the regenerative noise. Therefore, the control unit 33 prioritizes an increase in the regenerative electric energy obtained during deceleration rather than the reduction of regenerative noise in an environment in which regenerative noise is difficult to be noticed, so that it is possible to balance the reduction in the driver's discomfort caused by the regenerative noise and the increase in the obtained regenerative electric energy.

Note that the control unit 33 may estimate the degree of noise around the vehicle 10 based on the actual speed of the vehicle 10 or the unevenness of the surface on the road on which the vehicle 10 is traveling. In general, the higher the actual speed, the higher the noise during traveling. Therefore, the control unit 33 determines that the noise around the vehicle 10 is larger as the speed of the vehicle 10 measured by the vehicle speed sensor (not shown) mounted on the vehicle 10 increases, and reduces the adjustment amount. In this case, a table indicating the relationship between the speed of the vehicle 10 and the adjustment amount is stored in advance in the memory 22. Then, the control unit 33 may determine the adjustment amount by referring to the table.

Further, as the degree of unevenness of the road surface increases, the noise around the vehicle 10 when the vehicle 10 is traveling increases. As the degree of unevenness of the road surface increases, the amount of short-periodic variation in the wheel speed measured together with the speed by the vehicle speed sensor increases. Further, as the degree of unevenness of the road surface increases, the variation range of the acceleration of the vehicle 10 measured by an acceleration sensor (not shown) mounted on the vehicle 10 also increases. Therefore, the control unit 33 executes FFT on the measured wheel speed in the most recent predetermined period to calculate the respective frequency components of the wheel speed variation. The control unit 33 reduces the adjusting amount, as the variation component of the wheel speed at a predetermined frequency (e.g., several 100 Hz) increases. Alternatively, the control unit 33 may decrease the adjustment amount as the sum of the absolute values of the fluctuation amounts of the acceleration between the individual sampling points included in the latest predetermined period increases. In this case as well, the control unit 33 may determine the adjustment amount by referring to a table that is stored in advance in the memory 22 and indicates the relationship between the variation component of the wheel speed at a predetermined frequency or the absolute value sum of the fluctuation amounts of the acceleration and the adjustment amount.

In addition, it is assumed that the noise in the vehicle interior of the vehicle 10 is larger as the set volume of the speaker provided in the vehicle interior is larger and the device with audio output mounted in the vehicle 10 is turned on. Therefore, the control unit 33 may decrease the adjustment amount as the device with audio output is turned on and the set volume of the speaker provided in the vehicle interior increases. In this case as well, the control unit 33 may determine the adjustment amount by referring to a table that is stored in advance in the memory 22 and indicates the relationship between the set volume of the speaker and the adjustment amount.

Further, the control unit 33 may set the regenerative torque and the target torque so that the regenerative electric energy obtained when the vehicle 10 decelerates increases as the remaining amount of the battery decreases. In this case, for each remaining battery amount, a table representing the increment of the regenerative torque at each speed when the manual operation mode is applied to the vehicle 10 and the increment of the regenerative torque at each speed when the acceleration/deceleration control mode is applied to the vehicle 10 may be stored in advance in the memory 22. Then, the control unit 33 may determine the increment of the regenerative torque when the manual operation mode is applied or when the acceleration/deceleration control mode is applied by selecting a table corresponding to the remaining amount of the battery. Also in this case, similarly to the above-described embodiment, the adjustment amount of the increment of the regenerative torque at each speed is set so that the regenerative electric energy obtained when the acceleration/deceleration control mode is applied to the vehicle 10 is smaller than that when the manual operation mode is applied to the vehicle 10. Therefore, since the regenerative noise and the shock at the time of stopping in the case where the acceleration/deceleration control mode is applied to the vehicle 10 are suppressed, the discomfort felt by the driver is reduced. In this modification, the determination unit 32 may be omitted. In addition, as in the modification described above, the adjustment amount may be set so that the adjustment amount decreases as the remaining amount of the battery decreases or as the noise around the vehicle 10 or in the vehicle interior increases.

Furthermore, the control unit 33 may set the regenerative torque and the target torque when the vehicle 10 decelerates regardless of the remaining amount of the battery. In this case, in the map referred to for determining the regenerative torque when the acceleration/deceleration control mode is applied in the above-described embodiment, the regenerative torque at each speed may be set so that the regenerative torque is smaller by a predetermined adjustment amount than in the case where the manual operation mode is applied. In this modification, the determination unit 32 may be omitted. In addition, as in the modification described above, the adjustment amount may be set so that the adjustment amount decreases as the remaining amount of the battery decreases or as the noise around the vehicle 10 or in the vehicle interior increases.

The computer program for realizing the functions of the processor 23 of the ECU 15 according to the above-described embodiment or each modification may be provided in a form recorded on a computer-readable portable recording medium such as a semiconductor memory, a magnetic recording medium, or an optical recording medium.

What is claimed is:

1. A vehicle control device comprising:
a processor configured to control a motor mounted on a vehicle when the vehicle decelerates so that a regenerative electric energy obtained by the motor during deceleration of the vehicle when an acceleration/deceleration control mode is applied to the vehicle is smaller than the regenerative electric energy when the acceleration/deceleration control mode is not applied to the vehicle by a predetermined adjustment amount, the acceleration/deceleration control mode being a mode in which acceleration/deceleration of the vehicle is controlled according to a distance between the vehicle and a preceding vehicle.

2. The vehicle control device according to claim 1, wherein the processor decreases the adjustment amount as a remaining amount of a battery mounted on the vehicle decreases.

3. The vehicle control device according to claim 1, wherein the processor decreases the adjustment amount as a noise around the vehicle or in the vehicle interior increases.

4. A vehicle control method, comprising:
controlling a motor mounted on a vehicle when the vehicle decelerates so that a regenerative electric energy obtained by the motor during deceleration of the vehicle when an acceleration/deceleration control mode is applied to the vehicle is smaller than the regenerative electric energy when the acceleration/deceleration control mode is not applied to the vehicle by a predetermined adjustment amount, the acceleration/deceleration control mode being a mode in which acceleration/deceleration of the vehicle is controlled according to a distance between the vehicle and a preceding vehicle.

5. A non-transitory recording medium that stores a computer program for controlling a vehicle, the computer program causing a processor mounted on a vehicle to execute a process comprising:
controlling a motor mounted on the vehicle when the vehicle decelerates so that a regenerative electric energy obtained by the motor during deceleration of the vehicle when an acceleration/deceleration control mode is applied to the vehicle is smaller than the regenerative electric energy when the acceleration/deceleration control mode is not applied to the vehicle by a predetermined adjustment amount, the acceleration/deceleration control mode being a mode in which acceleration/deceleration of the vehicle is controlled according to a distance between the vehicle and a preceding vehicle.
